(19) United States
(12) Patent Application Publication
(10) Pub. No.: US 2016/0176728 A1
(43) Pub. Date: Jun. 23, 2016

(54) METHOD FOR PRODUCING MINERAL WATER RICH IN CALCIUM IONS AND MAGNESIUM IONS

(71) Applicant: Stone & Resource Industry R & D Center, Ji'an Township (TW)

(72) Inventors: Cheng-Shing Lo, Hualien City (TW); Ping-Yi Huang, Ji'an Township (TW); Chih-Shan Lin, Ji'an Township (TW)

(21) Appl. No.: 14/574,261

(22) Filed: Dec. 17, 2014

(51) Int. Cl. C02F 1/44

(52) U.S. Cl. CPC C02F 1/442; C02F 2103/08

(57) ABSTRACT

A method for producing mineral water from deep sea water includes: (a) filtering deep sea water using a first nano-filtration membrane, which is able to retain sulfate ions from permeating therethrough, so as to obtain sulfate ion-rich concentrated water and first permeate water; and (b) filtering the first NF-permeate water using a second NF membrane, which is able to retain calcium ions and magnesium ions from permeating therethrough, so as to obtain mineral water rich in calcium ions and magnesium ions.

### FIELD OF THE INVENTION

The invention relates to a method for producing mineral water, more particularly to a method for producing mineral water rich in calcium ions and magnesium ions.

### BACKGROUND OF THE INVENTION

Deep sea water (also called deep ocean water), which contains relatively large amounts of inorganic ions, has become one popular source for producing mineral water. Conventionally, reverse osmosis process or electrodialysis process may be utilized for producing the mineral water. However, the reverse osmosis process cannot perform selective filtration on the inorganic ions, and the electrodialysis process consumes relatively large amount of electric power which results in poor production efficiency.

### SUMMARY OF THE INVENTION

Therefore, the object of the present invention is to provide a method that may alleviate at least one of the aforementioned drawbacks of the prior art.

According to one aspect of the present invention, a method for producing mineral water rich in calcium ions and magnesium ions from deep sea water of the present invention may include the following steps of:

(a) filtering deep sea wafer using a first nano-filtration (NF) membrane which is able to retain sulfate ions frosts permeating therethrough, so as to obtain sulfate ion-rich concentrated water and first NF-permeate water; and

(b) filtering the first NF-permeate water using a second NF membrane which is able to retain calcium ions and magnesium ions from permeating therethrough, so as to obtain second NF-permeate water and the mineral water rich in calcium ions and magnesium ions.

According to another aspect of the present invention, a method for producing mineral water rich in calcium ions and magnesium ions from deep sea water may include the following steps of:

(a) subjecting deep sea water to reverse osmosis (RO) treatment using a reverse osmosis membrane, so as to obtain RO-permeate water and RO-concentrated water;

(b) filtering the RO-concentrated water using a first nano-filtration (NF) membrane which is able to retain sulfate ions from permeating therethrough, so as to obtain sulfate ion-rich concentrated water and first NF-permeate water; and

(c) filtering the first NF-permeate water using a second NF membrane which is able to retain calcium ions and magnesium ions from permeating therethrough, so as to obtain second NF-permeate water and mineral water rich in calcium ions and magnesium ions.

### BRIEF DESCRIPTION OF THE DRAWING

Other features and advantages of the present invention will become apparent in the following detailed description of the exemplary embodiment with reference to the accompanying drawing, of which:

FIG. 1 is a flow chart of an exemplary embodiment according to the present invention, illustrating a method for producing mineral water rich in calcium ions and magnesium ions.

### DETAILED DESCRIPTION OF THE EXEMPLARY EMBODIMENT

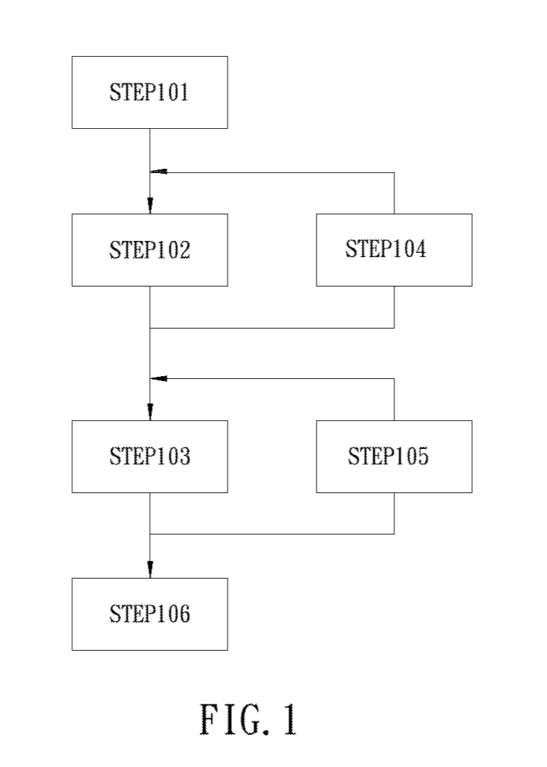

Referring to FIG. 1, the exemplary embodiment of a method for producing mineral water rich in calcium ions and magnesium ions from deep sea water according to the present invention includes steps as follows:

Step 101: subjecting deep sea water to reverse osmosis (RO) treatment using a reverse osmosis membrane, so as to obtain RO-permeate water and RO-concentrated water. In this embodiment, a weight ratio of magnesium ions with respect to calcium ions present in the RO-concentrated water ranges from 3 to 4. The reverse osmosis membrane may be, but is not limited to, DOW™ FILMTEC™ BW30-440i RO membrane. In this embodiment, the RO treatment is conducted at a feeding pressure ranging from 500 psi to 1000 psi, and a feeding temperature ranging from 6° C. to 25° C. A recovery rate of the RO treatment, which refers to a quotient where the volume of the RO-permeate water is divided by a sum of the RO-permeate water and the RO-concentrated water, ranges from 15% to 30%.

Step 102: filtering the RO-concentrated water using a first nano-filtration (NF) membrane which is able to retain sulfate ions from permeating therethrough, so as to obtain sulfate ion-rich concentrated water and first NF-permeate water. In this embodiment, the first NF membrane is able to retain the sulfate ions but allows passage of calcium ions as well as magnesium ions therethrough. It should be noted that the sulfate ions may react with the calcium ions to form calcium sulfate which may precipitate due to poor water solubility, thereby reducing the concentration of the calcium ions. In addition, high amounts of sulfate salts in potable water may lead to bitter taste or even diarrhea of consumers. In this embodiment, the first NF membrane may be, but is not limited to, FILMTEC™ NF270-4040 (commercially available from Dow company), ESNA Membrane ESNA1-LF2-LD (commercially available from Nitto Denko Hydranautics), or NF membrane M-N4040A9 (commercially available from Applied membranes Inc.). In this embodiment, Step 102 is conducted at a feeding pressure ranging from 50 psi to 250 psi, and a recovery rate of the first NF-permeate water (i.e., a quotient where the volume of the first NF-permeate water is divided by a sum of the first NF-permeate water and the sulfate ion-rich concentrated water) ranges from 20% to 80%. Preferably, based on one liter of the first NF-permeate water, the sulfate ions are present in an amount ranging from 45 mg to 285 mg, the magnesium ions are present in an amount ranging from 100 mg to 500 mg, and the calcium ions are present in an amount ranging from 50 mg to 600 mg. In this embodiment, sodium ions are in an amount ranging from 10000 mg to 20000 mg based on one liter of the first NF-permeate water. It should be noted that Step 102 may be conducted by directly filtering the deep sea water instead of the RO-concentrated water, and thus Step 101 may be omitted in other embodiments according to the present invention.

Step 103: filtering the first NF-permeate water using a second NF membrane which is able to retain calcium ions and magnesium ions from permeating therethrough, so as to obtain second NF-permeate water and mineral water rich in calcium ions and magnesium ions. In this embodiment, the second NF membrane may be, but is not limited to, NF membrane TM610 (commercially available from Toray). Preferably, Step 103 is conducted at a feeding pressure ranging from 50 psi to 250 psi, and a recovery rate of the second NF-permeate water (i.e., a quotient where the volume of the second NF-permeate water is divided by a sum of the second NF-permeate water and the mineral water rich in calcium ions and magnesium ions) ranges from 20% to 80%. In this embodiment, based on one liter of the mineral water, magnesium ions are present in an amount ranging from 300 mg to 5000 mg, and calcium ions are present in an amount ranging from 200 mg to 2000 mg.

It should be noted that the method of this exemplary embodiment may further comprise Step 104 of adding the sulfate ion-rich concentrated water, which is obtained from Step 102, to the RO-concentrated water after Step 102, and Step 102 is repeated so as to further extract residual ions (such as Ca²⁺ and Mg²⁺) in the sulfate ion-rich concentrated water.

It should be noted that the method of this exemplary embodiment may further comprise Step 105 of adding the second NF-permeate water, which is obtained from Step 103, to the first NF-permeate water after Step 103, and Step 103 is repeated so as to further extract residual ions (such as Ca²⁺ and Mg²⁺) in the second NF-permeate water.

It should be noted that the method of this exemplary embodiment may further comprise a step 106 of adding the RO-permeate water, which is obtained from Step 101, to the mineral water, so as to lower the concentration of sodium ions present in the mineral water. In this embodiment, the sodium ions are present in an amount of below 30 mg based on one liter of the mineral water after Step 106.

By utilizing the first and second NF membranes to perform selective filtration, the method of the present invention may remove the sulfate ions from the mineral water, as well as to increase the content of the calcium ions and magnesium ions. In addition, electrodialysis process can be omitted from the present invention, thereby resulting in relatively high production efficiency and relatively low costs.

The following examples are provided to illustrate the exemplary embodiment of the invention, and should not be construed as limiting the scope of the invention.

### EXAMPLES

### Preparation of First NF-Permeate Water

### Example 1

Deep sea water, which contains 410 mg/L of calcium ions, 1350 mg/L of magnesium ions, 11140 mg/L of sodium ions, and 2660 mg/L of sulfate ions, was subjected to reverse osmosis treatment using FILMTEC™ BW30-440i RO membrane at a feeding pressure of 600 psi and a feeding temperature between 6° C. to 7° C., so as to obtain RO-concentrated water and RO-permeate water. The RO-permeate water was obtained at a recovery rate of 20%, and the RO-concentrated water contains 511 mg/L of calcium ions, 1780 mg/L of magnesium ions, 12353 mg/L of sodium ions, and 3210 mg/L of sulfate ions. Thereafter, a first nano-filtration membrane NF270-4040 was utilized to filter the RO-concentrated water at a feeding pressure of 150 psi, so as to obtain first NF-permeate water of Example 1 and sulfate ion-rich concentrated water. The first NF-permeate water of Example 1 contains 243 mg/L of calcium ions, 389 mg/L of magnesium ions, 10210 mg/L of sodium ions, and 48 mg/L of sulfate ions (see Table 1 below). The first NF-permeate water was obtained at a recovery rate of 20%.

### Examples 2 and 3

The first NF-permeate water of each of Examples 2 and 3 was obtained by a method similar to that of Example 1. The only difference resides in that the first NF-permeate water of each of Examples 2 and 3 was obtained at a different recovery rate during the nano-filtration process. The ion content in the first NF-permeate water of each of Examples 2 and 3 is listed in Table 1.

TABLE 1

| | RO- | | | |
|---|---|---|---|---|
| | concentrated | First NF permeate water | | |
| | water | Example 1 | Example 2 | Example 3 |
| Recovery | 20 | 20 | 50 | 80 |
| Rate (%) | | | | |
| Na⁺ (mg/L) | 12353 | 10210 | 11220 | 11350 |
| K⁺ (mg/L) | 523 | 352 | 390 | 420 |
| Ca²⁺ (mg/L) | 511 | 243 | 280 | 290 |
| Mg²⁺ (mg/L) | 1780 | 389 | 420 | 450 |
| Cl⁻ (mg/L) | 2200 | 15920 | 16540 | 16840 |
| SO₄²⁻ (mg/L) | 3210 | 48 | 240 | 282 |

### Preparation of Mineral Water Rich in Calcium Ions and Magnesium Ions

### Example 1-1

A Toray TM610 Nano-filtration membrane was utilized to filter the first NF permeated water of Example 1 at a feeding pressure of 150 psi and a recovery rate of 20% to obtain second NF-permeate water and mineral water rich in calcium ions and magnesium ions. The mineral water was then subjected to another nano-filtration process using the Toray TM610 nano-filtration membrane at a feeding pressure of 150 psi, so as to adjust the ion content therein. The resultant mineral water of Example 1-1 contains 340 mg/L of calcium ions and 670 mg/L of magnesium ions (see Table 2 below). The mineral water was obtained at a recovery rate of 20%. Thereafter, the RO-permeate water of Example 1 was added into the mineral water for lowering the sodium concentration, so as to obtain a diluted mineral water which contains 3.5 mg/L of calcium ions, 20 mg/L of magnesium ions, and 30 mg/L of sodium ions.

### Examples 1-2 and 1-3

The mineral water of each of Examples 1-2 and 1-3 was obtained by the method similar to that of Example 1-1. The main difference resides in that the mineral water of each of Examples 1-2 and 1-3 was obtained at a recovery rates different from that of Example 1-1. The ion content of the mineral water of each of Examples 2 and 3 was measured and is listed in Table 2 below.

TABLE 2

| | Mineral Water | | | | | |
|---|---|---|---|---|---|---|
| | Example 1 | | Example 2 | | Example 3 | |
| Recovery | 20 | | 50 | | 80 | |
| Rate (%) | | | | | | |
| Nono-filtration | once | twice | once | twice | once | twice |
| (Number | | | | | | |
| of times) | | | | | | |
| Na⁺ (mg/L) | 10930 | 11000 | 11230 | 11400 | 11800 | 11960 |
| K⁺ (mg/L) | 390 | 420 | 420 | 470 | 440 | 440 |
| Ca²⁺ (mg/L) | 310 | 340 | 350 | 400 | 470 | 790 |
| Mg²⁺ (mg/L) | 540 | 670 | 620 | 960 | 1040 | 2500 |
| Cl⁻ (mg/L) | 16650 | 16840 | 16840 | 17791 | 18875 | 22801 |
| SO₄²⁻ (mg/L) | 72 | 121 | 96 | 250 | 240 | 410 |

To sum up, by utilizing the first and second NF membranes to perform selective filtration, the method of the present invention can remove the sulfate ions from the mineral water, as well as increase the content of the calcium ions and the magnesium ions. In addition, electrodialysis process can be omitted from the present invention, thereby resulting in relatively high production efficiency and relatively low production costs.

While the present invention has been described in connection with what is considered the most practical embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A method for producing mineral water rich in calcium ions and magnesium ions from deep sea water, comprising the following steps of:
(a) filtering deep sea water using a first nano-filtration (NF) membrane which is able to retain sulfate ions from permeating therethrough, so as to obtain sulfate ion-rich concentrated water and first NF-permeate water; and
(b) filtering the first NF-permeate water using a second NF membrane which is able to retain calcium ions and magnesium ions from permeating therethrough, so as to obtain second NF-permeate water and mineral water rich in calcium ions and magnesium ions.

2. The method of claim 1, wherein, based on one liter of the first NF-permeate water, the sulfate ions are present in an amount ranging from 45 mg to 285 mg.

3. The method of claim 1, wherein, based on one liter of the first NF-permeate water, the magnesium ions are present in an amount ranging from 100 mg to 500 mg, and the calcium ions are present in an amount ranging from 50 mg to 600 mg.

4. The method of claim 1, wherein, based on one liter of the mineral water, the magnesium ions are present in an amount ranging from 300 mg to 5000 mg.

5. The method of claim 1, wherein, based on one liter of the mineral water, the calcium ions are present in an amount ranging from 200 mg to 2000 mg.

6. The method of claim 1, further comprising:
adding the second NF-permeate water to the first NF-permeate water after step (b); and
repeating step (b) after addition of the second NF-permeate water to the first NF-permeate water.

7. A method for producing mineral water rich in calcium ions and magnesium ions from deep sea water, comprising the following steps of:
(a) subjecting deep sea water to reverse osmosis (RO) treatment using a reverse osmosis membrane, so as to obtain RO-permeate water and RO-concentrated water;
(b) filtering the RO-concentrated water using a first nano-filtration (NF) membrane which is able to retain sulfate ions from permeating therethrough, so as to obtain sulfate ion-rich concentrated water and first NF-permeate water; and
(c) filtering the first NF-permeate water using a second NF membrane which is able to retain calcium ions and magnesium ions from permeating therethrough, so as to obtain second NF-permeate water and mineral water rich in calcium ions and magnesium ions.

8. The method of claim 7, wherein, in step (a), a weight ratio of magnesium ions with respect to calcium ions in the RO-concentrated water ranges from 3 to 4.

9. The method of claim 7, wherein, based on one liter of the first NF-permeate water, the sulfate ions are present in an amount ranging from 45 mg to 285 mg.

10. The method of claim 7, wherein, based on one liter of the first NF-permeate water, the magnesium ions are present in an amount ranging from 100 mg to 500 mg, and the calcium ions are present in an amount ranging from 50 mg to 600 mg.

11. The method of claim 7, wherein, based on one liter of the mineral water, the magnesium ions are present in an amount ranging from 300 mg to 5000 mg.

12. The method of claim 7, wherein, based on one liter of the mineral water, the calcium ions are present in an amount ranging from 200 mg to 2000 mg.

13. The method of claim 7, further comprising:
adding the sulfate ion-rich concentrated water to the RO-concentrated water after step (b); and
repeating step (b) after the addition of the sulfate ion-rich concentrated water.

14. The method of claim 7, further comprising:
adding the second NF-permeate water to the first NF-permeate water after step (c); and
repeating step (c) after addition of the second NF-permeate water to the first NF-permeate water.

15. The method of claim 7, further comprising a step of adding the RO-permeate water obtained in step (a) into the mineral water to adjust an amount of sodium ions to be below 30 mg based on one liter of the mineral water.
